(19) United States
(12) Patent Application Publication
(10) Pub. No.: US 2010/0100482 A1
(43) Pub. Date: Apr. 22, 2010

(54) Intermediate Data Generation For Transaction Processing

(75) Inventor: Dick C. Hardt, Vancouver (CA)

Correspondence Address: PERLEY-ROBERTSON, HILL & MCDOUGALL LLP, 1400-340 Albert Street, OTTAWA, ON, K1R 0A5, CA

(73) Assignee: SXIP IDENTITY CORP., Vancouver, BC (CA)

(21) Appl. No.: 12/523,754

(22) PCT Filed: Jan. 23, 2008
(86) PCT No.: PCT/CA08/00095

§ 371 Date: Jul. 20, 2009

Related U.S. Application Data
(60) Provisional application No. 60/886,194, filed on Jan. 23, 2007.

(51) Int. Cl. G06Q 20/00; G06F 17/30

(52) U.S. Cl. 705/44; 707/802; 705/39; 707/E17.044

(57) ABSTRACT

An indirect transaction processor performs rules based processing to verify online transactions. The indirect transaction processor can match indirect indirect data sets to valid data sets used in conventional transaction approval to provide users anonymity in transactions. User approval of transactions can also be implemented, as can other business rules to permit delegated approval and authorization.

### CROSS REFERENCE TO RELATED APPLICATIONS

This application claims the benefit of U.S. Provisional Application No. 60/886,194 filed Jan. 23, 2007, which is incorporated herein by reference.

### FIELD OF THE INVENTION

The present invention relates generally to the creation of data for transaction processing. More particularly, the present invention relates to the creation of intermediate or indirect data values used in the processing of on-line transactions.

### BACKGROUND OF THE INVENTION

Online commerce is reliant upon the processing of credit and debit cards for the completion of transactions. As online commerce began, online merchants provided reassurance to customers that transactions were secure through the use of secure connections, such as Secure Sockets Layer (SSL) connections. SSL connections increased the security of the transaction by preventing third parties from intercepting the transmission and surreptitiously obtaining the credit card number.

However, customer resistance is not the only impediment to online transactions. Because there is no face to face contact with the customer, it was difficult to ensure that the transaction was in fact authorized by the customer. In a real world transaction, possession of the card is often considered as authorization, and further authentication can be performed by verification of a signature against the signature on the signature strip. In an online transaction there was no simple mechanism for obtaining proof of possession of the card to establish authorization.

To address this problem, a card verification value (CVV) was printed on the back of the credit card. Credit card receipts would not contain this value, nor would the 3 magnetic stripes on credit cards. Thus, the number would only be available to the card holder and the card issuer. During an online transaction, the card number, expiry date and CVV number can be used to reduce the likelihood of fraud.

Other advances have includes the Verfied by Visa™ system that allows merchants that subscribe to a service that prompts the customer for a password that is a shared secret between the customer and the card issuer. This provides authentication of the customer by obtaining verification that the customer knows a secret shared between the card issuer and the card holder. From a merchant perspective, it reduces the probability of a charge-back and thus reduces the cost associated with the transaction. From a card-holder perspective, the password is provided in a pop up window that sends the data directly to the credit-processing facility bypassing the merchant. As a result, the merchant will not have all the data required to perform a transaction, and thus, the chances that the card will be fraudulently used in another transaction are greatly diminished. One problem associated with the Verified by Visa system is that an unscrupulous merchant could create a popup window simulating the Verified by Visa system in an attempt to engage in phishing for the password. Detection of this attempt requires a moderate level of user sophistication.

Other card companies have moved towards offering one-time use credit card numbers (also referred to as disposable credit card numbers). In such systems, a user connects to a credit card issuer and upon authenticating requests a single use credit card number. The card number, an expiry date and optionally a CVV code are created and entered into the system. This number can then be provided to a merchant who can then process the card in a transparent fashion.

Because the generated value is disposable, there is little concern on the part of either the merchant or the card holder that a disposable value will be released. Even if there is a security compromise, and the disposable values are released, they cannot be reused. Security is pushed onto the relationship between the card holder and the issuer. Some systems have attempted to automate this process by providing a web-browser plug-in that allows a user to right click on a field and insert a generated disposable card number.

It should be noted that in order for a transaction to be processed without the physical presence of the card. Thus, although great progress has been made toward making a transaction more secure, these advancements have been designed to minimize the likelihood of fraud and charge-backs which are disadvantageous to both the merchant and the card-issuer. These advancements have not been, thus far, directed to protecting the privacy and personal information of the card holder. The card holder is still required to provide accurate contact and biographical data to allow processing of the transaction. This is not always beneficial, as it may be advantageous to hide the identity of a card holder and maintain it as separate from the transaction.

It should also be noted that there is, at present, no way to delegate the approval of a transaction, or delegate the authority to use a card (other than surrender of the card details).

It is, therefore, desirable to provide a system and method for providing enhanced transaction processing in online transactions.

### SUMMARY OF THE INVENTION

One object of the present invention to obviate or mitigate at least one disadvantage of previous transaction approval and authentication systems.

In a first aspect of the present invention there is provided a method for generating indirect transaction data for use in a transaction. The method comprises the steps of receiving a request for indirect transaction data; generating a set of indirect transaction data and an associated set of transaction conditions in accordance with the received request; and transmitting the generated set of indirect transaction data.

In embodiments of the first aspect of the present invention, the request for indirect transaction data is received from a user, and the generated set of indirect transaction data is transmitted to the user. The step of generating indirect transaction data can include generating indirect values for identity information. The identity information can be selected from a list including a name, an address, a credit card number and an email address. In other embodiments, at least one element in the set of indirect transaction data is a nonce, and the transaction conditions are selected from a list including requiring the collection of metadata, requiring cardholder authorization, requiring credit card issuer approval, requiring a specified merchant, requiring a transaction below a specified limit and requiring use of the indirect data within a defined time window. The step of generating the set of indirect transaction data can be followed by a step of storing the indirect transaction data and the associated set of transaction conditions.

In a second aspect of the present invention, there is provided a method for approving a transaction based on indirect transaction data. The method comprises receiving a request to approve a transaction, the request containing indirect transaction data; retreiving a set of transaction conditions associated with the received indirect transaction data; and transmitting a transaction approval in response to the received request if the retrieved transaction conditions are satisfied.

In embodiments of the second aspect of the present invention, the step of retrieving transaction conditions can include retrieving a set of direct transaction data associated with the indirect transaction data. The indirect transaction data can include at least one unique element to permit retrieval of the transaction conditions. The retrieved transaction conditions can include obtaining a transaction approval from an external approval agent such as a credit card holder or a credit card issuer.

In a third aspect of the present invention, there is provided an indirect transaction processor. The processor generates indirect transaction data and authorizes transaction based on indirect transaction data. The indirect transaction processor comprises an indirect data generator and an approval engine. The indirect data generator generates indirect transaction data and a set of transaction conditions associated with a set of direct transaction data, and stores the direct transaction data, the generated indirect transaction data and the transaction conditions upon generation. The approval engine receives requests to authorize transactions based on indirect transaction data, and retrieves direct transaction data and at least one transaction condition associated with the received indirect transaction data so that it can approve the received requests upon satisfying the transaction conditions associated with the received indirect transaction data.

In embodiments of the third aspect of the present invention, the processor can further include a policy database for storing the direct transaction data, the generated transaction data and the transaction conditions created by the indirect data generator for later retrieval by the approval engine. The approval engine can include an external approval interface for determining if transaction conditions reliant on external factors are satisfied. The approval engine can include an analysis engine for analyzing received requests to determine if at least one of the retrieved transaction conditions has been satisfied.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an illustration of a system of the present invention in a network setting;

FIG. 2 is a block diagram illustrating a system of the present;

FIG. 3 is a flowchart illustrating a method of generating indirect transaction data; and

FIG. 4 is a flowchart illustrating a method of generating indirect transaction data.

### DETAILED DESCRIPTION

Generally, the present invention provides a method and system for generating indirect information associated with a payment method to provide the user with additional functionality related to payment processing.

In conventional transaction processing, a credit card, or debit card, number is submitted to a merchant along with a set of associated data. This information is then submitted to a payment processing network, and an entity in the network authorizes the transaction. The set of associated data can include expiry dates, a CVV, number, cardholder name, address and contact information. This identity information is often requested for the purposes of authorization, but is also stored in a database after authorization has been obtained. The storing of this information has become a privacy issue as the security policies of many merchants have come into question. Authorization of the transaction is performed by the card issuer in accordance with a set of rules designed with the intent of detecting fraud. Typically, if a transaction appears to be fraudulent, many card issuers will decline authorization, and contact the card holder to inquire about the transaction.

If a user visits an electronic merchant and purchases a product, the address to which the product is shipped is typically stored. The shipping address may be confirmed with the credit card authorization service as an acceptable shipping address.

The user's name is often stored by online merchants and can be used to build an internal user profile. Related but separate companies can, in theory, collaborate with each other to build a model of user behavior based on purchasing habits. This is disconcerting to many users.

In an embodiment of the present invention, there is provided an indirect transaction processor. This server provides the user with the ability to create indirect information that can be associated with a transaction but cannot necessarily be used by a merchant to identify the user. Additionally, transaction conditions can be set which must be satisfied during the transaction processing in order for a transaction based on the indirection information to be approved. Although the following discussion is framed around the use of a credit card, those skilled in the art will appreciate that debit and other transactions methods can be performed using the same system.

The indirect transaction processor can be a part of the payment processing network, and can be associated or integrated with the card issuer, or can be a distinct entity. The user is able to create a connection to the indirect transaction processor, either directly or through an intermediary, and issue a request for the generation of an indirect data set. The indirect data set can include any of an account number (such as a credit card or debit card account number), an expiry date and CVV number associated with the account number, a name, contact information such as an address and a phone number, an email address or an instant message address. The indirect data set can be generated randomly (or pseudorandomly), in accordance with values associated with stored user identity information, and in accordance with values provided by the user. In other embodiments, the indirect data set can be generated based on user input.

The indirect transaction processor, upon generating the indirect data set, stores the indirect data, any transaction conditions associated with the data and enough information to permit the direct data set associated with the credit card or other payment device to be identified. The indirect data set is then provided to the user. When the user receives the indirect data set, it can be used in a transaction with a merchant.

When the merchant attempts to obtain authorization for the transaction, the authorization request is routed to the indirect transaction processor, which can confirm that the data provided to the merchant site corresponds to a set of issued data. The indirect transaction processor can then perform an approval process. If the indirect transaction processor is distinct from the card issuer, the approval process can include forwarding the actual user information to the card issuer for approval through the payment processing network or through a direct connection, and providing the result of the approval to the merchant.

From the perspective of the merchant, the process can be made to be transparent. This allows existing infrastructure to be employed and avoids the necessity of redesigning existing merchant infrastructure to accommodate the new system.

In addition to identity information being included in the request for an indirect data set, the user, in various embodiments, can include a request for approval delegation in the request, resulting in the establishment of rules to be used by a rule based processor in the indirect transaction processor. For instance, if the indirect data set includes an indirect account number, a set of business rules can be established to determine the length of time that the indirect account number is valid for. The lifespan of the indirect data set can be limited to a set number of transactions, a limited duration of time, or can be allowed to be used for an indefinite amount of time until a user cancels the value. These rules are also referred to as transaction conditions.

Transaction conditions can be established for the processing of indirect data sets. The simplest rule is that the approval process can proceed if the data submitted by the merchant site matches an indirect data set. If such a match exists, the transaction can then proceeds to the standard authorization process, whereby the available credit limits are checked. Other conditions can be applied, with consultation of the user. Indirect data sets can be bound to a single merchant, so that a particular data set can only be used with a single merchant and will be declined by all other merchants. Indirect data sets bound to a single merchant can also be cancelled and an alert generated if another merchant submits the data.

The rules processing can also be used to obtain cardholder approval of any transaction. Thus, when a user initiates a transaction, during the approval process, he can be prompted by an out of band communication from the indirect transaction processor to approve the transaction. With such communications, the user can also be prompted to provide meta data associated with the transaction. The approval can be based on the provided meta data in certain embodiments.

At this time, an example will be presented. This example is intended to be illustrative, and not limiting in scope. Reference is made below to specific elements, which are numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

A user makes use of a connection to a data network, such as the Internet, through an interface such as web browser 100. The user directs web browser 100 to connect to a merchant website 102 over data connection 104. The user accesses pages hosted on merchant site 102, to perform a transaction. Pages hosted on merchant site 102 may include forms for which a form mapping server 106 is accessed over connection 108 to permit the user of a form filling application. Alternatively, the request for data may be handled by an Identity Agent.

When the user requires a set of transaction data to provide to the merchant site, a decision can be made as to whether the merchant site can be provided the direct data, or whether the merchant site should be provided a set of indirect transaction data. If the user decides to provide indirect transaction data, a connection is made to indirect transaction processor 110 over datapath 112. This connection can be manually initiated by the user, or can be performed on behalf of the user by an agent, such as the aforementioned Identity Agent or by another such proxy. The user can use connection 112 to request indirect transaction data. The requested indirect transaction data can include indirect values for any of the information that is to be provided to the merchant site. The request for indirect transaction data may specify transaction conditions that must be satisfied prior to the approval of the transaction. Such transaction conditions can include a requirement that user approval of a transaction be obtained, that the transaction is below a predefined limit, or that the merchant is a specific merchant. It should be understood that in some embodiments, the transaction conditions can specify only conventional credit card approval conditions. Upon generation of the indirect transaction data and the transaction conditions, the direct data along with the indirect data and the transaction conditions are stored in policy database 114.

The indirect data set, or confirmation of the generation thereof, is provided back to the browser 100 over data path 112. It should be understood that the user can generate indirect data sets at any point in time, and need not do so immediately before a transaction, though if a transaction condition includes a time limit on the validity of the data, the generated indirect transaction data would have to be used within the proscribed time period. The indirect transaction data is, in this example, forwarded to the merchant site 102 over data path 116, which is preferably a secure data connection. The merchant site 102 requests approval of the transaction through the payment processing network 118 over datapath 120. Preferably, payment processing network 118 is the same network used for conventional credit approvals to prevent the need for a redundant transaction network.

The approval request is transmitted through payment processing network 118 and to Indirect Transaction Processor 110 over connection 122.

Indirect transaction processor 110 then retrieves the transaction conditions associated with the indirect transaction data from policy database 114. Some transaction conditions may require external input to be satisfied. In one example, the user can be asked to approve the transaction over data connection 124, in another example, the direct transaction data can be transmitted to an external approval authority 126 over data connection 128. External approval authority 126 can be a conventional credit card processor that is required to approve the transaction using its own rules.

Upon determining that the transaction conditions have been satisfied, the indirect transaction processor 110 can record the transaction in a transaction database 130 and transmit approval of the transaction into payment processing network 118 over connection 132. The approval is then relayed to the merchant site 102 from payment processing network 118 over connection 134. The merchant site 102 can then provide the user with an indication that the transaction has been completed through message 136.

The transaction conditions set by indirect transaction processor 110 can be thought of as business rules specifing any number of business scenarios including time sensitive windows, merchant specific lists, and other scenarios that will be well understood by those skilled in the art. Other conditions may include a requirement for the user to be prompted to provide an expense description that can be stored in transaction database 130 to ease reconciliation of accounts at a later date.

One skilled in the art will appreciate that this system can be used to permit a number of transactions that otherwise cannot be performed.

A cardholder can create indirect transaction data containing all the basic card data, but change the name associated with the card. This allows the cardholder to designate other people to use the card, and maintain the ability to track who used the account for a certain charge. This could be used by a parent to allow a child to perform an online transaction, or by a corporate accounting group that uses a single account for a number of sales associates. Transaction conditions can be established on such transactions to set a transaction limit, a spending limit per time interval, a list of authorized merchants etc. User meta data for a transaction can also be required so that when a particular user initiates a transaction he can be prompted to provide billing or accounting information for the transaction.

The provision of meta data can be set as either a condition that must be satisfied for approval of a transaction, or as an optional facility (which can be treated as a transaction condition requiring that the user be provided an opportunity to provide meta data). This can be separated from the approval process, and the meta data can be provided to a distinct approver. This would allow a parent to permit a child to use an indirect data set restricted to a set of merchants, limited in the amount that can be charged, and then further require per transaction approval by the card holder. One skilled in the art will appreciate that these scenarios need not be performed with each set of indirect transaction data having the same card number.

In the case of adult entertainment sites, a card holder could obscure his real identity by providing the indirect transaction data. This could include an indirect address.

In situations where a service or a subscription to a service is purchased, indirect address data is of little consequence. However, indirect address data becomes relevant if a user is purchasing a product that is to be shipped.

Where shipping occurs to an indirect address, the merchant can ship to the provided address, where a product will be received by an entity acting as the agent for the user. Upon receipt of the shipped product, the agent can determine the address on the basis of the supplied indirect identity information, and then reship the product back to the designated address. In an alternate embodiment, a shipping service can have access to the indirect transaction data, and can determine that a provided address is an indirect address. The package, having been received by such a shipper, can then be relabeled and sent directly to the direct address stored by the indirect transaction processor.

Similarly, the indirect data set can contain an email address that will redirect email to an alternate address. Systems for performing email redirection of this sort are known in the art.

Indirect data sets can include indirect phone numbers, which can either connect to a system that then proceeds to forward the call, or they can be phone numbers recognized by advanced intelligent networks (AIN) telephony systems, which then remap the phone number to the correct destination.

The indirect transaction processor 100 can be used in interactions that are not financial transactions. If a user is registering for a service, indirect identity data can be obtained from the indirect transaction processor 110 for submission to a service. Indirect identity information can include such data as a shipping address, a telephone number, an email address, and an instant messaging address. Each of these identity data elements can be redirected as described above or using techniques that will be understood by those skilled in the art.

To facilitate matching the generated indirect transaction data to direct transaction data, it is preferable that at least one element of the generated indirect data be a nonce or another key that can aid in matching the indirect data set to the direct data set during transaction processing.

One skilled in the art will appreciate that the present invention provides both indirect identity information, and transaction monitoring. They can be implemented separately from each other or in conjunction with each other without departing from the scope of the present invention.

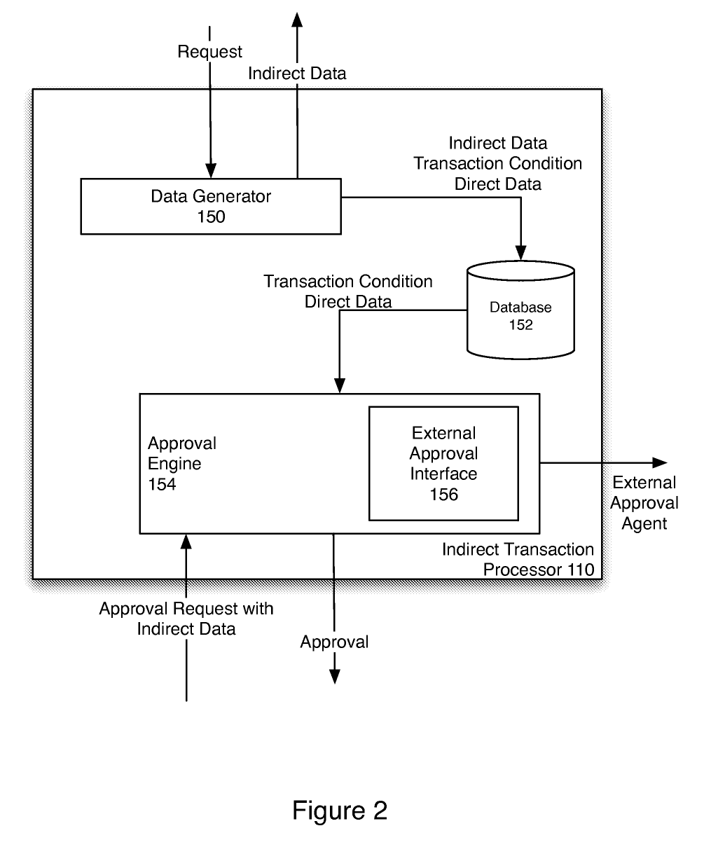

FIG. 2 illustrates an embodiment of indirect transaction processor 110. An indirect data generator 150 receives requests for indirect transaction data. These requests typically contain either direct information or sufficient information to allow the data generator 150 to determine the direct information that may already be known to the processor 110. The generator 150 generates indirect transaction data along with any necessary transaction conditions. The generation of indirect transaction data can include the use of a random or pseudo-random sequence generator to create indirect data values. It is preferable for at least one of the values to be sufficiently unique so that it can serve as an index value for later lookups. Such values can be nonces.

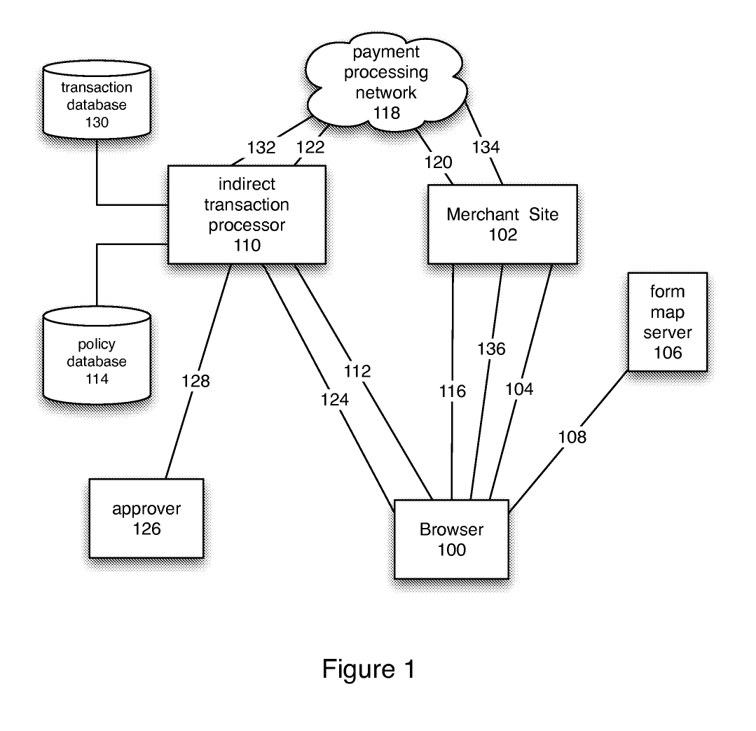

The direct data, the indirect data and the transaction conditions are stored in a database 152. One skilled in the art will appreciate that the database can be external to the processor 110, much as policy database 114 is external to the processor 110 in FIG. 1. Not all of the direct data elements need be stored in database 152 for each set of indirect data, so long as they can be reconstructed from other data accessible to the processor 110.

An approval engine 154 receives requests for approval of transactions using indirect data from external entities. The approval engine then obtains direct data and transaction conditions associated with the indirect data received with the approval request from database 152. Upon satisfying the transaction conditions (which typically requires that the direct data be used to obtain an external approval through external approval interface 156), the approval engine 154 can transmit approval of the transaction to the requesting party.

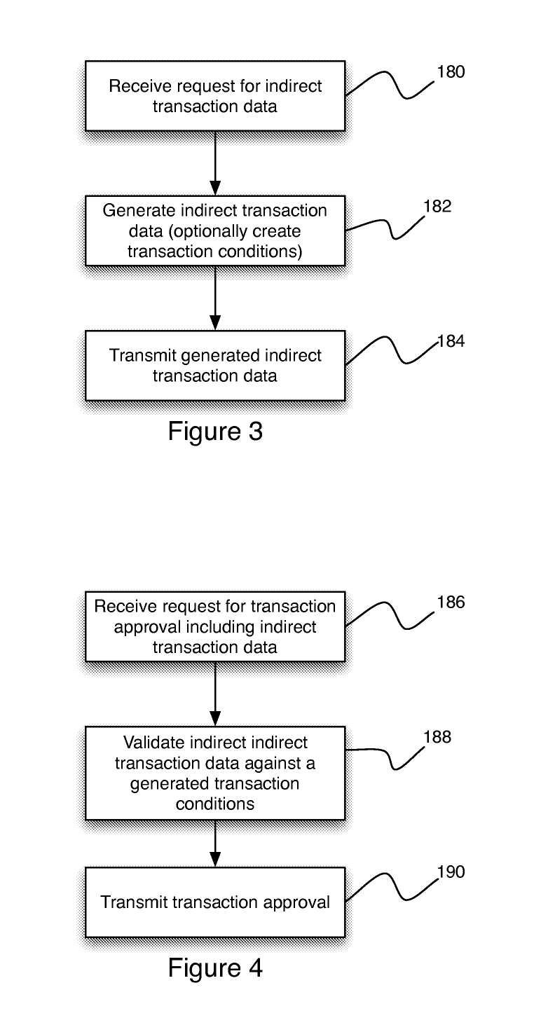

FIG. 3 is a flowchart illustrating a method of the present invention. In step 180, a request is received for indirect transaction data. This request preferably includes either an identifier that can be mapped to direct transaction data, or includes the direct transaction data. In accordance with the received request, indirect transaction data is generated in step 182. Additionally, a set of transaction conditions can also be generated in accordance with the user request. In step 184, the generated transaction conditions are transmitted to the requesting party. In other embodiments, the generated indirect transaction data and transaction conditions are stored after they are generated for later use.

The transaction conditions can be generated in accordance with the request, which may also involve multiple communications with the requesting user.

It should be noted that the transaction conditions can be thought of as a type of indirect data that will later have to be processed prior to transaction approval.

FIG. 4 is a flowchart illustrating a method of the present invention. In step 186, a request for a transaction approval is received. The transaction approval includes indirect transaction data. In step 188, the indirect transaction data set is validated against a set of previously generated transaction conditions. The transaction conditions can be retrieved from a data store where they are associated with the indirect transaction data. A variety of transaction conditions can be used in the validation process, as described above. Upon validation of the transaction conditions, a transaction approval can be issued to the requesting party in step 190.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of generating indirect transaction data for use in a transaction comprising:
receiving a request for indirect transaction data;
generating a set of indirect transaction data and an associated set of transaction conditions in accordance with the received request; and
transmitting the generated set of indirect transaction data.

2. The method of claim 1 wherein the request for indirect transaction data is received from a user, and the generated set of indirect transaction data is transmitted to the user.

3. The method of claim 1 wherein the step of generating indirect transaction data includes generating indirect values for identity information.

4. The method of claim 3 wherein the identity information is selected from a list including a name, an address, a credit card number and an email address.

5. The method of claim 1 wherein at least one element in the set of indirect transaction data is a nonce.

6. The method of claim 1 wherein the transaction conditions are selected from a list including requiring the collection of metadata, requiring cardholder authorization, requiring credit card issuer approval, requiring a specified merchant, requiring a transaction below a specified limit and requiring use of the indirect data within a defined time window.

7. The method of claim 1 wherein the step of generating the set of indirect transaction data is followed by a step of storing the indirect transaction data and the associated set of transaction conditions.

8. A method of approving a transaction based on indirect transaction data, the method comprising:
receiving a request to approve a transaction, the request containing indirect transaction data;
retreiving a set of transaction conditions associated with the received indirect transaction data; and
transmitting a transaction approval in response to the received request if the retrieved transaction conditions are satisfied.

9. The method of claim 8 wherein the step of retrieving transaction conditions includes retrieving a set of direct transaction data associated with the indirect transaction data.

10. The method of claim 8 wherein the indirect transaction data includes at least one unique element to permit retrieval of the transaction conditions.

11. The method of claim 8 wherein the retrieved transaction conditions include obtaining a transaction approval from an external approval agent.

12. The method of claim 11 wherein the external approval agent is the holder of a credit card associated with the indirect transaction data.

13. The method of claim 11 wherein the external approval agent is the issuer of a credit card associated with the indirect transaction data.

14. An indirect transaction processor for generating indirect transaction data and for authorizing transactions based on indirect transaction data, the processor comprising:
an indirect data generator for generating indirect transaction data and a set of transaction conditions associated with a set of direct transaction data, and for storing the direct transaction data, the generated indirect transaction data and the transaction conditions;
an approval engine for receiving a request to authorize transactions based on indirect transaction data, for retrieving direct transaction data and at least one transaction condition associated with the received indirect transaction data, for approving the received requests upon satisfying the transaction conditions associated with the received indirect transaction data.

15. The processor of claim 14 further including a policy database for storing the direct transaction data, the generated transaction data and the transaction conditions for later retrieval.

16. The processor of claim 14 wherein the approval engine includes an external approval interface for determining if transaction conditions reliant on external factors are satisfied.

17. The processor of claim 14 wherein the approval engine includes an analysis engine for analyzing the received request to determine if at least one of the retrieved transaction conditions has been satisfied.
